(19) United States
(12) Patent Application Publication
(10) Pub. No.: US 2014/0177701 A1
(43) Pub. Date: Jun. 26, 2014

(54) SYSTEM AND METHOD FOR TIME BUDGET ACHIEVEMENT IN REAL-TIME VIDEO ENCODING

(71) Applicant: THOMSON LICENSING, Issy de Moulineaux (FR)

(72) Inventors: Adarsh Golikeri, San Diego, CA (US); Gad Moshe Berger, Dayton, NJ (US); Ferran Valldosera, Princeton, NJ (US); Hua Yang, Princeton, NJ (US)

(73) Assignee: THOMSON LICENSING, Issy de Moulineaux (FR)

(21) Appl. No.: 13/726,798

(22) Filed: Dec. 26, 2012

(51) Int. Cl. H04N 7/26

(52) U.S. Cl. CPC H04N 19/00133
USPC 375/240.02

(57) ABSTRACT

A method and apparatus for encoding video is provided. A pre-analysis processor processes unencoded video data formed from a series of video pictures into respective video segments. An allocation processor allocates a first encoding time budget to a respective video segment respective video segment based on a size of the respective segment a target frame rate for the respective video segment, a second encoding time budget to individual pictures that form the respective video segment based on a picture-level complexity value and a type of picture, the second time budget for all individual pictures being substantially equal to the first time budget, and a third encoding time budget to individual blocks that form respective ones of the individual pictures based on a coding mode for the individual block and a block complexity value, the third time budget for all blocks being substantially equal to the second time budget for the respective individual picture that includes the blocks. An encoding processor encodes respective video segments using the third time budget to encode the video segment using the first, second and third time budgets.

### FIELD

The present arrangement provides a system and method associated with real-time video encoding and, more specifically, a system which intelligently allocates and achieves a time budget during real-time video encoding.

### BACKGROUND

Real-time encoding is an important feature of modem video encoders. Video encoding is a computationally intensive process, requiring the interaction between several core modules such as spatial and temporal prediction, motion estimation and compensation, mode decision, transform coding, quantization and entropy coding. Natural video sequences have widely varying characteristics (motion, texture, special different coding complexities, etc). Adding to the complexity of the encoding process is the fact that encoders may be implemented on various software and hardware platforms each with their own distinct and varying processing capabilities. Thus, a drawback associated with real-time video encoding is that there is a large variability in the time it takes to encode video data. Moreover, it is difficult to predict the encoding time consumed by different encoding units.

An attempt to remedy the deficiencies identified above focuses on allocating a time budget for use during encoding. One manner of allocating time budgets relates to allocating a time budget for each Picture to be encoded based on the target frame rate alone. Then, after accounting for the overhead time within a Picture, the Mode Decision and Motion Estimation modules at the Macroblock level are constrained to execute in a fixed amount of time. The achievement mechanism used to implement the above allocation uses fixed, pre-determined thresholds to determine whether or not to evaluate certain coding modes in order to achieve the real-time constraint. However, there are certain weaknesses associated with this approach to time budgeting for real-time video encoding. First, allocating a constant Picture-level encoding time and Macroblock encoding time is not optimal because of the different coding complexities associated therewith. Second, the above method of time budgeting focuses solely on individual pictures and does not take into account the carry-over time between pictures and/or between macroblocks.

Another path to achieving real-time video coding efficiency focuses on reconfiguring an encoder depending on the fullness of a multi-frame input buffer. To maintain a target buffer fullness and hence real-time encoding, a controller module reduces encoder complexity when the buffer fullness is high and increases complexity when the buffer fullness is low. Complexity control is achieved by either changing Picture-types or by switching between different Motion Estimation schemes. However, there are also drawbacks associated with this mode of achieving real-time coding efficiency. Specifically, while this method works well for smooth sequences, the encoder cannot be properly reconfigured in order to handle abrupt changes in complexity. An additional drawback of method which relies on tight control of the multi-frame input buffer is the inability to estimate the complexity of the incoming video signal because of possible computation overhead resulting in an inability to adapt to the video signal characteristics.

Yet another path for achieving real-time coding efficiency is based on a frame-level control module for allocation and a per-frame complexity control module for achievement. In this method, the allocation module computes a target encoding time for a next frame depending on the total delay (or waiting time) experienced by the frames in the input buffer. If the coding delay is too large, then frames may be dropped. The complexity control module then uses a Lagrangian rate-distortion-complexity cost estimation to encode the frames within the target encoding time. The rate and distortion statistics of the co-located Macroblock in the previous Picture (in temporal order) and the Quantization parameter (QP) are used to model the coding behavior of the current Macroblock. This model is used to determine whether it would be more efficient to use a SKIP mode or evaluate all the remaining Macroblock coding modes. The drawback associated with this method is similar to those discussed above. Specifically, this real-time encoding scheme does not adapt to the input video signal characteristics during the time budget calculation. Specifically, this method fails to estimate the macroblock complexity prior to actual encoding and does not model the performance of coding modes other than SKIP mode.

Therefore, a need exists for a system that provides an efficient real-time video encoder that remedies these and other deficiencies described hereinabove.

### SUMMARY

In a first embodiment, an apparatus for encoding video is provided. A pre-analysis processor processes unencoded video data formed from a series of video pictures into respective video segments. An allocation processor allocates a first encoding time budget to a respective video segment respective video segment based on a size of the respective segment a target frame rate for the respective video segment, a second encoding time budget to individual pictures that form the respective video segment based on a picture-level complexity value and a type of picture, the second time budget for all individual pictures being substantially equal to the first time budget, and a third encoding time budget to individual blocks that form respective ones of the individual pictures based on a coding mode for the individual block and a block complexity value, the third time budget for all blocks being substantially equal to the second time budget for the respective individual picture that includes the blocks. An encoding processor encodes respective video segments using the third time budget to encode the video segment using the first, second and third time budgets.

In another embodiment, a method of encoding video is provided. The method includes the activities of processing unencoded video formed from a series of video pictures into respective video segments; allocating a first encoding time budget to a respective video segment respective video segment based on a size of the respective segment a target frame rate for the respective video segment; allocating a second encoding time budget to individual pictures that form the respective video segment based on a picture-level complexity value and a type of picture, the second time budget for all individual pictures being substantially equal to the first time budget, and allocating a third encoding time budget to individual blocks that form respective ones of the individual pictures based on a coding mode for the individual block and a block complexity value, the third time budget for all blocks being substantially equal to the second time budget for the respective individual picture that includes the blocks. The method further includes encoding respective video segments using the third time budget to encode the video segment using the first, second and third time budgets.

The above presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

To the accomplishment of the foregoing and related ends, certain illustrative aspects of embodiments are described herein in connection with the following description and the annexed drawings. These aspects are indicative, however, of but a few of the various ways in which the principles of the subject matter can be employed, and the subject matter is intended to include all such aspects and their equivalents. Other advantages and novel features of the subject matter can become apparent from the following detailed description when considered in conjunction with the drawings.

### BRIEF DESCRIPTION OF THE DRAWINGS

FIG. 1 is a block diagram of an encoder according to invention principles;

FIG. 2 is a flow diagram detailing an exemplary operation of the encoder according to invention principles; and

FIG. 3 is a flow diagram detailing an exemplary operation of the encoder according to invention principles.

### DETAILED DESCRIPTION

The subject matter is now described with reference to the drawings, wherein like reference numerals are used to refer to like elements throughout. In the following description, for purposes of explanation, numerous specific details are set forth in order to provide a thorough understanding of the subject matter. It can be evident, however, that subject matter embodiments can be practiced without these specific details. In other instances, well-known structures and devices are shown in block diagram form in order to facilitate describing the embodiments.

It should be understood that the elements shown in the FIGS. may be implemented in various forms of hardware, software or combinations thereof Preferably, these elements are implemented in a combination of hardware and software on one or more appropriately programmed general-purpose devices, which may include a processor, memory and input/output interfaces.

The present description illustrates the principles of the present disclosure. It will thus be appreciated that those skilled in the art will be able to devise various arrangements that, although not explicitly described or shown herein, embody the principles of the disclosure and are included within its spirit and scope.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read only memory (“ROM”) for storing software, random access memory (“RAM”), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

As used in this application, the terms “component” and/or “module” are intended to refer to hardware, or a combination of hardware and software in execution. For example, these elements can be, but are not limited to being, a process running on a processor, a processor, an object, an executable running on a processor, and/or a microchip and the like. By way of illustration, both an application running on a processor and the processor can be a component or a module. One or more components and/or modules can reside within a process and may be localized on one system and/or distributed between two or more systems. Functions of the various components and/or modules shown in the figures can be provided through the use of dedicated hardware as well as hardware capable of executing software in association with appropriate software.

The present invention advantageously provides a video encoder apparatus for real-time video encoding. The video encoder apparatus intelligently allocates time budgets at each of three different levels within the video. The present apparatus advantageously allocates encoding time budgets for each of a Group Of Pictures (GOP) level, a Picture level and Macroblock (MB) level. By advantageously taking into account the time budget for each of the three levels, the video encoder advantageously ensures efficient real-time encoding of video data.

The time budget allocation is based on time-complexity modeling at the Picture and MB level. The time budget allocation is, in some ways, similar but not equivalent to the rate control function performed by a rate control module of a video encoder. As is known, the rate control module of video encoders allocate bit budgets among different coding units of an encoder to maintain a target bitrate among the encoded video data stream. While the present encoder performs rate control as discussed, the video encoder further advantageously couples adaptive time budget allocation for each coding unit that encodes a respective level of the video data (e.g. GOP, Picture and MB). The adaptive time budget allocation performed by the video encoder adapts based on at least one video encoding metric that is used by an time budget allocation processor or module. The at least one video encoding metric may include at least one of (a) video signal characteristics; (b) actual encoder configuration; and (c) computing resources (or platform capabilities).

Thus, the video encoder apparatus advantageously performs time budget allocation via a time budget allocation processor that automatically determines how the video encoder should make best use of its time in order to achieve real-time performance. Once an efficient time budget has been allocated to the respective levels of the video data to be encoded, the video encoder further advantageously achieves the determined time budget using a time budget “achievement” module thereby forming a complete time control system. In one embodiment, the time budget allocation module and time budget achievement module are performed in separate modules. In another embodiment, the time budget allocation and achievement functions are performed by a single module.

To accomplish the inventive time budget achievement, the video encoder uses time-complexity modeling to control an encoding decision mode for the third level being encoded thereby. In one embodiment, time-complexity modeling is used to control a Macroblock level mode decision process in order to achieve the time-budget required for real-time video encoding. The time budget achievement algorithm adapts according to the at least one video encoding metric. For example, as referenced above, the at least one video encoding metric may include at least one of (a) video signal characteristics; (b) actual encoder configuration; and (c) computing resources (or platform capabilities).

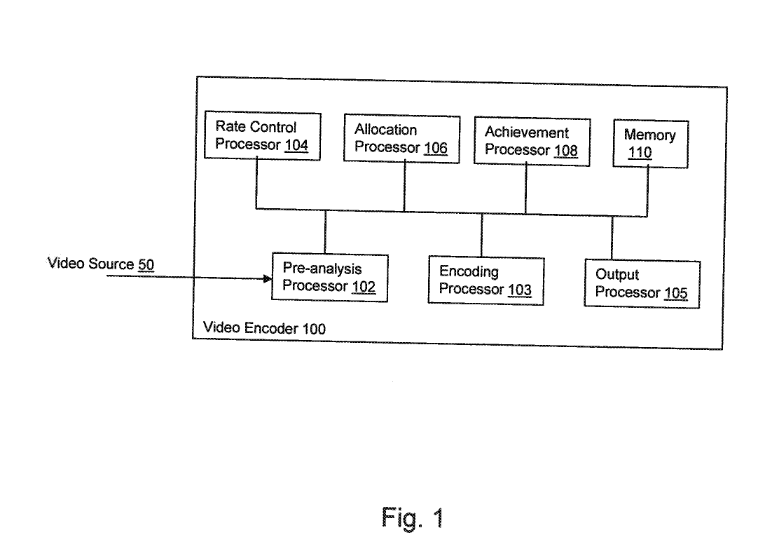

FIG. 1 is a block diagram of an exemplary video encoder 100 that advantageously allocates and achieves a time budget for efficiently performing real-time video encoding. The video encoder 100 advantageously allocates video encoder resources to ensure optimal assignment and utilization of system resources to facilitate real-time video encoding to maximize encoding efficiency. The video encoder 100 advantageously allocates encoding time on three encoding levels. As used herein, the term encoding time refers to an amount of time assigned to an encoding processor of the video encoder 100 for encoding a particular level of the video data stream. A goal of the present video encoder 100 is to allocate encoding time for individual levels such that the total encoding time meets a target frame rate. The video encoder 100 allocates encoding time among the different Pictures within a GOP, subject to a target frame rate. The video encoder 100 uses an accurate time-complexity modeling approach at the Picture and MB level such that encoding time for each Picture and MB is modeled as a function of complexity of the video data which is a property of the video sequence itself.

Furthermore, once the video encoder has completed the time budget allocation function for a respective video data stream, the video encoder 100 advantageously achieves the real-time encoding time budget using the same accurate time-complexity modeling approach applied at a macroblock encoding decision mode at the Macroblock level. By using the same time-complexity modeling in both the time budget allocation and time budget achievement phases of encoding, the computing resources of the video encoder 100 may be minimized further improving the real-time coding efficiency. The video encoder 100 may achieve the time budget at a time associated with and consumed by different Macroblock coding modes is advantageously measured and tracked to generate a Macroblock complexity measurement. The Macroblock complexity measurement requires low computational overhead to generate and may be advantageously used by the encoder for other encoding processes such as Picture-type selection and Rate Control. Thus, the achievement scheme of the video encoder dynamically adapts to the actual encoder performance and platform capabilities.

The adaptive time budget allocation and achievement algorithm may be implemented in any type of video encoder 100. For example, the video encoder 100 may be any standard video encoder including, but not limited to a video encoder that encodes video according to an H.264/AVC encoding scheme, an H.264/SVC encoding scheme, an MPEG-4 encoding scheme and/or an MPEG-2 encoding scheme. These are described for purposes of example only and the principles of the present invention may be embodied in any video encoder that encodes video data according to any video encoding standard.

As shown in FIG. 1, the video encoder 100 includes a pre-analysis processor 102 that selectively receives video data to be encoded in real-time from a video data source 50. The video data received by the pre-analysis processor 102 is uncompressed video pictures that are formatted in according to a predetermined video data format. The pre-analysis processor performs a plurality of important functions associated with real-time video encoding such as scene-cut detection, picture-level complexity analysis and Rho-table generation for a particular GOP, and Picture-level Rate control. The pre-analysis module may also determine an optimum GOP size and the optimal GOP pattern (i.e. I, P or B picture types) for the input video pictures from source 50.

The video data from source 50 is processed by the pre-analysis processor 102 into a plurality of different levels, each level of the video pictures are to be encoded separately. The video data is organized at a first level as a Group of Pictures (GOP) which represents a predetermined sequence of pictures. At a second level, hereinafter, the Picture level, each picture of the sequence of pictures is divided into non-overlapping blocks of a predetermined shape having a predetermined size. The shape and size of the non-overlapping blocks is dependent upon the type of coding scheme implemented by the video encoder 100. These blocks into which each picture is divided forms the third level to be encoded and is termed Macroblocks which are the most basic unit of any video encoder 100.

The video encoder 100 includes an encoding processor 103 that is coupled to the pre-analysis processor 102. The encoding processor 103 selectively receives pre-processed video data that is unencoded and encodes the pre-processed video data according to a video encoding scheme. The encoding processor 103 may encode the pre-processed video data according to any or all parameters associated with a particular video encoding standard or scheme. In one embodiment, the video encoder 100 may be an H.264/AVC video encoder and the video data received from the source 50 is uncompressed YUV formatted video data. In this embodiment, the pre-analysis processor 102 organizes the video data as a GOP having a predetermined size and the individual Pictures are divided into Macroblocks that are 16×16 pixels. The encoding processor 103 selectively encodes the pre-processed video data based on the parameters defined by the H.264/AVC encoding standard.

An output processor 105 is coupled to the encoding processor 103 for selectively outputting the video data encoded by the encoding processor 103 to a destination system. The output processor 105 may include a transmission function that enables transmission of the encoded data via a communication network. Additionally, the output processor 105 may also further format and/or partition the encoded video data to enable efficient transmission to a destination system. This operation is describe for purposes of example only and the output processor 105 may perform any operation that enables the encoded video data to be provided to any destination system either locally or remotely located from the video encoder 100.

A rate control processor 104 is coupled to the pre-analysis processor 102 and implements a rate control scheme for the video data to be encoded. The rate control processor 104 allocates bits to each Picture of a particular GOP with the least amount of distortion and subject to a target bit rate. In one embodiment, the rate control processor 104 may implement a constant bit rate (CBR) encoding scheme. In another embodiment, the rate control processor 104 may be inactive such that the resulting encoding scheme is a variable bit rate (VBR) encoding scheme. The rate control processor 104 may allocate collectively to a GOP as well as on sub-levels of the GOP including the Picture level and the Macroblock level.

The video encoder 100 also includes an allocation processor 106 that dynamically allocates a time budget associated with different organizational levels (GOP, Picture and MB) within a video data stream. The allocation processor 106, at the GOP level, derives a time budget based on a GOP size (i.e. number of coded Pictures in the GOP) and the target frame rate. The allocation processor 106 further advantageously determines an amount of encoding time associated with a previous GOP that was unused. For example, if the previous GOP had a time budget but the actual time it took to encode the GOP was lower than the allocated time budget, the allocation processor 106 may use any remaining time in determining and allocating a time budget for a present GOP. The allocation processor 106 estimates an overhead time associated with coding a current GOP from previously measured encoding time values and subtracts the estimated value from the GOP budget to yield the GOP encoding time budget.

The allocation processor 106, in response to determining the time budget associated with the first level (GOP), a second level time budget is determined The second level of encoding is at the Picture level and the individual Picture level encoding time budgets can be derived depending on the operating mode of the encoder. For CBR (Constant Bit Rate) encoding, the derivation is based on the corresponding bit budgets assigned by the Rate Control processor 104 which has previously considered a picture-level complexity measurement while allocating bit budgets subject to a maximum GOP bit budget. If the encoding scheme is a VBR (Variable Bit Rate) encoding scheme, the derivation of the time budget for the second (Picture) level is based on a Picture-level complexity metric that was calculated by the pre-analysis processor. The complexity metric defines a complexity (e.g. an amount of energy) associated with at least one characteristic of the picture of the video data. The complexity metric may include at least one of (a) motion; (b) texture; (c) special effect; and (d) auxiliary picture characteristic. Additionally, when the allocation processor 106 is determining the second level time budget for the Picture level, the type of picture (e.g. I frame, P frame, B frame) is also taken into account.

Upon determining the time budget at the second level, that is to say, for each Picture of the GOP, the allocation processor 106 determines and allocates a time budget at the third level for each Macroblock that forms each Picture of the GOP. At the MB level, the allocation processor 106 determines and allocates time budgets in proportion to a local complexity measure associated with each Macroblock. The complexity measure used has a very low computational overhead and is also used by other modules within the encoder, such as Picture-type selection and Rate Control. The allocation processor 106 measures a performance of the encoding processor 103. The performance of the encoding processor 103 is measured in terms of actual encoding time associated with a particular encoding operation (e.g. GOP encoding, Picture level encoding, MB encoding) and actual coded bits at each level of encoding. The performance measurement is utilized by the allocation processor to generate at least one model parameter that is used for allocating a time budget for a subsequent GOP and the Pictures and Macroblocks associated with the subsequent GOP. The at least one model parameter is automatically updated after each coded Picture resulting in the dynamically adaptable time budget allocation which considers actual encoder performance and platform capabilities to adaptively update a time budget allocation within each of the GOP, Picture and Macroblock levels in the video data stream prior to encoding thereof.

The video encoder 100 further includes an achievement processor 108 and a memory 108 to which the achievement processor 108 is coupled. The achievement processor 108 enables the time budgets allocated by the allocation processor 106 to be achieved to facilitate efficient real-time encoding by the encoding processor 103. The achievement processor 108 uses the time-complexity modeling to control the Macroblock level mode decision process in order to achieve the allocated time-budget required for real-time video encoding by the encoding processor 103. The achievement processor 108 executes an achievement algorithm that dynamically adapts according to the at least one video signal characteristics as well as the actual encoder configuration and computing resources available to the video encoder 100.

The achievement processor 108 uses an accurate time-complexity modeling approach at the Macroblock mode level whereby an encoding time associated with each Macroblock coding mode is modeled as a function of complexity. The time consumed by different Macroblock coding modes is measured and tracked, and because the Macroblock complexity measurement requires very low computational overhead to generate, the complexity measurement may also be used for other purposes such as Picture-type selection and Rate Control. The achievement scheme dynamically adapts to the actual encoder performance and platform capabilities.

The achievement processor 108 receives a time budget associated with a particular Macroblock as determined by the allocation processor 106. For the allocated time budget for the Macroblock, the achievement processor evaluates a coding cost associated with all available coding modes that may be applied to the particular Macroblock. In order to evaluate or “code” each mode, the encoder has to perform spatial or temporal prediction, motion estimation and compensation and residue coding (transformation, quantization and entropy coding). Therefore, the mode decision process is computationally intensive. Often, the mode decision process (along with the motion estimation) consumes the greatest portion of the encoding time. Hence, the objective is to reduce the computational burden at the mode decision stage in order to achieve the Macroblock time-budget that has been allocated for the particular Macroblock. The number and types of coding modes evaluated by the achievement processor 108 may include mandatory coding modes whereby all coding modes designated as mandatory are evaluated prior to selection thereof Other non-mandatory coding modes may also be evaluated by the achievement processor 108 if a time associated with evaluating non-mandatory coding modes allows the achievement processor 108 to remain within the encoding time budget allocated to the particular Macroblock and still have sufficient time for the encoding processor 103 to actually the particular Macroblock according to one of the MB coding modes. In response to evaluating the coding modes (either mandatory only or mandatory and non-mandatory), the achievement processor 108 selects a coding mode that is determined to be the least costly (e.g. least computationally intensive) to encode thereby providing the most compression-efficient coding mode for the particular Macroblock.

During the code mode evaluation process, the achievement processor 108, for each coding mode evaluated, calculates a ratio representing an actual time required to evaluate a particular coding to a complexity value of the particular Macroblock. These ratios represent as mode complexity map and may be stored in memory 110. Memory 110 being a separate component is described for purposes of example only and the memory may be resident within any of the above described processors and be accessible by the achievement (or other) processers depending on the computational operation being performed. The achievement processor 108 selectively queries the mode complexity map for each coding mode that has not yet been evaluated to determine if a time remaining in the allocated encoding time budget will be sufficient to evaluate the next previously unevaluated coding mode.

Once the coding mode for the particular Macroblock having the lowest computational cost is selected, the achievement processor 108 repeats the evaluation for a subsequent Macroblock of the Picture. When all Macroblocks of a particular picture have been evaluated and encoded, the achievement processor 108 repeats this process for Macroblocks of a subsequent picture until all Macroblocks of all pictures that form the GOP have been encoded. Thereafter, these operations are repeated for subsequent the Macroblocks of the pictures of subsequent GOPs.

In one embodiment, the video encoder 100 may be an H.264/VC video encoder. The achievement processor 108 may achieve the time budget allocated for each Macroblock by the allocation processor 108. The Macroblock mode decision process for an H.264/AVC encoder selects coding for each type of picture to be encoded (I, P and B pictures). For I Pictures, the available MB coding modes are Intra_{—}16×16, Intra_{—}4×4 and Intra_PCM. These modes support spatial prediction only. For P Pictures, the available MB coding modes include all the Intra modes, SKIP, Inter_{—}16×16, Inter_{—}8×8, Inter_{—}8×16 and Inter_{—}16×8. The Inter_{—}8×8 also supports sub-partitions of sizes 8×4, 4×8 or 4×4. Within the Inter modes, only uni-directional temporal prediction is allowed. For B Pictures, the available MB coding modes include all the Intra and Inter modes mentioned above, with the addition of the DIRECT mode. Within the Inter modes, both unidirectional (forward or backward) and bidirectional (forward and backward) temporal prediction are supported. Most encoders evaluate some or all of these coding modes. For each mode, a Rate-Distortion cost is obtained. Next, the mode with the least cost is selected as the final coding mode, since this is the most compression efficient option. The achievement processor 108 evaluates each mode indicated as mandatory and evaluates additional coding modes as the achievement processor 108 determines sufficient time exists from the allocated time budget to evaluate those coding modes. The determination as to which coding modes are evaluated is performed using the mode complexity map that is selectively updated to include the ratio of actual coding time for a particular mode and the complexity measurement associated with the respective Macroblock being encoded.

The above discussion of the video encoder being an H.264/AVC encoder is described for purposes of example only. With suitable modifications based on the principles of the algorithm that control operation of the video encoder 100 can also be implemented on other standard video encoders. For example, the Macroblock coding modes and partition sizes that are discussed in this section are unique to H.264/AVC. One skilled in the art could readily substitute coding modes and MB size based on the particular encoding scheme being used by the encoder. The achievement scheme described above may operate in any other type of video encoder so long as a value corresponding to the time budget allocation for each Macroblock is available.

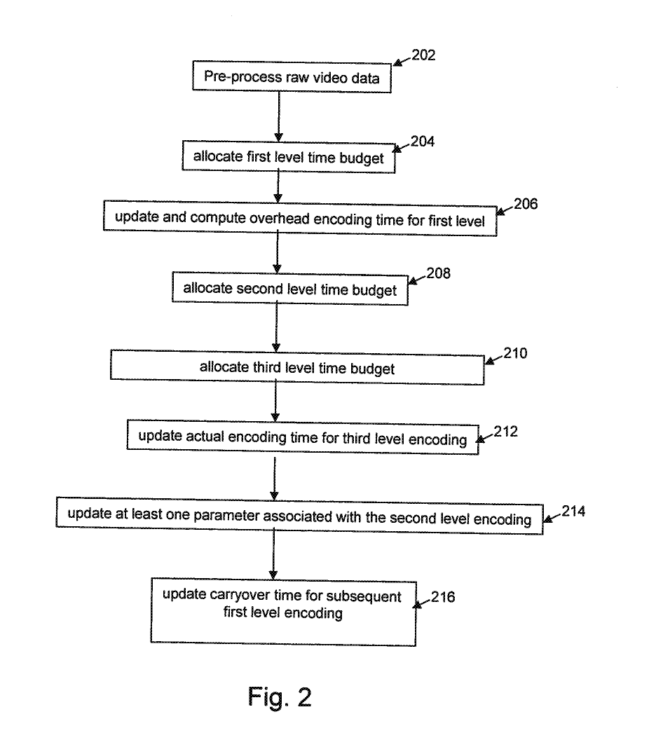

FIG. 2 is an exemplary flow diagram detailing an algorithm that may be executed by the video encoder 100 of FIG. 1. The algorithm described in FIG. 2 is a time budget allocation algorithm that adaptively and intelligently allocates a time budget with various encoding stages used when encoding video data. In one embodiment, the algorithm of FIG. 2 is executed by the allocation processor 106 of FIG. 1. In another embodiment, the algorithm as a whole or in part may be executed by any one of (or a combination of) any processor components shown in FIG. 1.

In block 202, the pre-analysis processor (102 in FIG. 1) receives uncompressed video data including a plurality of individual video pictures. The pre-analysis processor performs several important functions such determining a size for each respective GOP's, scene-cut detection, picture-level complexity analysis and Rho-table generation for GOP and Picture-level Rate control. In block 202, the pre-analysis processor also determines the optimum GOP size and the best GOP pattern (i.e. I, P or B picture types) for the input video pictures. Therefore, a GOP consists of a sequence of Pictures which are divided into non-overlapping, square blocks of a fixed size.

At block 204, a first coding level time budget is allocated. The first level coding level is the coding associated with the Group of Pictures (GOP). The time budget for each GOP can be calculated from the current GOP size as determined by the pre-analysis processor, the target frame rate (in frames per second). Additionally, the first coding level time budget may also be based on the remaining time left from the actual encoding of the immediately preceeding GOP. Therefore, for the current GOP, its calculated time budget in accordance Equation 1 which provides:

$$\text{?} ) = \frac{N}{{( FR )}^{Target}} + {T}_{Carryover} \\ \text{?} \text{indicates text missing or illegible when filed} \qquad ( 1 )$$

Where N represents a GOP size (e.g. number of individual pictures in the current GOP), (FR)^{Target} represents a target frame rate (frames/second) and T_{Carryover} reprsents a difference between a calculated time budget for a previous GOP and an actual time taken to encode the previous GOP. For the very first GOP, T_{Carryover} equals 0 and is calculated and updated after the last Picture in the current GOP has been encoded. The T_{Carryover} is used to maintain the real-time frame rate over consecutive GOPs.

In block 206, the overhead time for the first coding level is computed and updated. The total time required to encode a particular GOP can be split into two parts—overhead time and encoding time. Overhead time can be generally defined as time spent by the encoder on tasks that do not directly contribute to the Macroblock encoding process such as the time it takes for the pre-analysis processor to execute all of its defined functions. This is overhead time because these processes execute prior to the actual encoding stage performed by the encoding processor (103 in FIG. 1). In one embodiment, a function performed by the pre-analysis processor that contributes to overhead time are the Marcoblock level statistics and complexity metrics calculated for each Macroblock. However, the output of this function does not add to total encoding time because the complexity metric calculated by the pre-analysis processor is also used in the MB-level time budget allocation. Hence, the PreProcess module is important but it does not directly contribute to the encoding time. Other contributors to overhead time may include function call overhead, loop overhead, etc. An important observation is that the overhead time for different pictures of the same picture type is fairly constant and hence can be tracked via a sliding window approach with good accuracy.

After Picture, has been pre-processed by the pre-analysis processor, block 206 measures and updates the overhead time T_{overhead} for the current picture type using a sliding window average of a pre-process time associated with the last W_{O} coded pictures of the same type as defined in Equation 2 which states

$${T}_{overhead} = \frac{1}{{W}_{o}} \cdot \text{?} ( \text{?} ) \\ \text{?} \text{indicates text missing or illegible when filed} \qquad ( 2 )$$

In Equation 2, W_{O} represents the sliding window of a predetermined number of previously coded individual pictures. Furthermore, T_{overhead} is tracked separately for each type of picture to be coded by the video encoder.

In block 208, a second coding level time budget is allocated based on the total time budget allocated for the first coding level. In this embodiment, the second coding level is the picture level encoding and the time budget for the picture level encoding is determined based on the time budgeted to the respective GOP from which the current Picture is found.

Picture-level encoding time can be generally defined as time spent by the encoder on tasks that directly contribute to the Macroblock encoding process. This typically involves motion estimation and compensation (for inter pictures), spatial prediction (for intra and inter pictures), mode decision, transform, quantization and finally entropy coding. The encoding time mainly depends on the allocated bits (in CBR mode) and the picture coding complexity. In an embodiment where the encoder is a variable bit encoder, the picture coding complexity may be used alone. At the Picture level, the goal is to optimally distribute the computed GOP budget

$${( \text{?} )}^{\text{?}}$$

$$\text{?} \text{indicates text missing or illegible when filed}$$

among the individual Pictures. Let i be the index of a Picture in coding order within the current GOP.

To allocate a time budget within the second coding level for the picture level encoding stage, it is determined whether the current picture I is the first picture to be coded in the current GOP. The system initializes the time values according to Equation 3 which provides:

$$( {T}_{GOP} ) \text{?} = ( {T}_{GOP} ) \text{?} \\ ( {T}_{GOP} ) \text{?} = 0 \\ \text{?} \text{indicates text missing or illegible when filed} \qquad ( 3 )$$

Wherein the remaining time for the current GOP is equal to the calculated coding time for the GOP and the actual encoding time is equal to 0.

Before encoding a Picture with coding index i, a minimum encoding time

$$\text{?}$$

$$\text{?} \text{indicates text missing or illegible when filed}$$

required for all the remaining pictures in this GOP is determined The encoding time available for this GOP is obtained by subtracting the total overhead time as derived in Equation 1 from the allocated GOP level budget as shown in Equation 4:

$$\text{?} = ( {T}_{GOP} \text{?} - \text{?} {( \text{?} )}_{i} \\ \text{?} \text{indicates text missing or illegible when filed} \qquad ( 4 )$$

Thereafter, the encoding time for the current picture is calculated according to Equation 5 which provides:

$$( \text{?} \text{?} = \frac{\text{?} \cdot ( Bits \text{?}}{\text{?} \text{?} \cdot ( Bits \text{?}} \cdot \text{?} \\ \text{?} \text{indicates text missing or illegible when filed} \qquad ( 5 )$$

Where θ represents a model parameter for Picture i, (Bits)ᵢ^{Calc} represents a total amount of allocated bits for current Picture i obtained from Picture-level Rate Control. It is assumed that the bits allocated by a rate control processor (104 in FIG. 1) has considered Picture-level complexity while allocating the bit-budgets. The model parameter θ is defined as the ratio between the actual encoding time and the actual coded bits of a given Picture type as shown in Equation 6:

$$θ = \frac{( \text{?} \text{?}}{( Bits \text{?}} \\ \text{?} \text{indicates text missing or illegible when filed} \qquad ( 6 )$$

Model parameter θ is required to account for the different coding times of different Picture types. We can define θ_{I}, θ_{P} and θ_{B}, as model parameters for I, P and B Pictures types respectively. The GOP pattern decision (i.e. the Picture-type assignment) has already been made by the PreAnalysis processor. Hence, when evaluating Equation 5, the appropriate model parameter is plugged in, depending on the Picture-type. Extensive experiments with a variety of video sequences have shown that the formulation in Equation 5 results in optimum use of the encoding time budget.

In an embodiment of a video encoder that does not using Rate Control (for example, in Variable Bit Rate mode), a Picture-level complexity metric can be used in place of allocated bits in Equation 5. In this embodiment that is not using rate control, the model parameter θ represents the ratio between the actual encoding time and the actual complexity of a given Picture type. In fact, as will be discussed below, in the Macroblock-level time budget allocation, an MB-level complexity metric that can be averaged over all the Macroblocks may be used to yield a Picture-level complexity value that may be used.

To calculate the time budget for each Picture, we look to the coding modes available for the Macroblocks that comprise the respective picture. In the embodiment, where the video encoder is an H.264/AVC encoder the following coding modes for the following types of pictures are available. For I Pictures, the available MB coding modes are Intra_{—}16×16, Intra_{—}4×4 and Intra PCM. These modes support spatial prediction only. For P Pictures, the available MB coding modes include all the Intra modes, SKIP, Inter_{—}16×16, Inter_{—}8×8, Inter_{—}8×16 and Inter_{—}16×8. The Inter 8×8 also supports sub-partitions of sizes 8×4, 4×8 or 4×4. Within the Inter modes, unidirectional temporal prediction is allowed. For B Pictures, the available MB coding modes include all the Intra and Inter modes, with the addition of the DIRECT mode. Within the Inter modes, both unidirectional (forward or backward) and bidirectional temporal prediction are supported.

The modes are then examined to find the one that is the least time consuming. It should be noted that in case of SKIP or DIRECT mode (for P and B Pictures respectively), the encoder makes use of inferred motion information and hence little or no additional computation (such as spatial or temporal prediction or Motion Estimation) is necessary. For I Pictures, there is no equivalent to SKIP or DIRECT mode. Intra_{—}16×16 is chosen as the mandatory mode since it consumes much less time compared to Intra_{—}4×4, but far more coding efficient than Intra_PCM. Another property of these chosen modes (SKIP, DIRECT and Intra_{—}16×16) is that their encode time is fairly constant and independent of the video content.

The calculated Picture level budget is then constrained by the minimum Picture coding time

$$( \text{?} ) \text{?} . \\ \text{?} \text{indicates text missing or illegible when filed}$$

This is defined as the total time required to encode all the Macroblocks of the Picture with the least time consuming mode, without evaluating any other coding mode. M represents the number of Macroblocks in every Picture and

$$\text{?}$$

$$\text{?} \text{indicates text missing or illegible when filed}$$

represents the time required to encode a Macroblock with a particular coding mode Mode, without evaluating any other coding mode and

$${( \text{?} )}_{\text{?}}$$

$$\text{?} \text{indicates text missing or illegible when filed}$$

represents the least time consuming mode. Then, we can write the following equations 7 and 8

$$( \text{?} \text{?} = \text{?} ( \text{?} \text{?} = \{ \begin{matrix}\text{?} ( \text{?} \text{?} & for I Picture \\ \text{?} ( \text{?} \text{?} & for P Picture \\ \text{?} ( \text{?} \text{?} & for B Picture\end{matrix} \\ \text{?} \text{indicates text missing or illegible when filed} \qquad ( 7 )$$

Such that

$$( \text{?} ) \text{?} = max ( ( \text{?} ) \text{?} , ( \text{?} ) \text{?} ) \\ \text{?} \text{indicates text missing or illegible when filed} \qquad ( 8 )$$

Once the second picture level coding time budget is calculated, the third coding level time budget is allocated. The third coding level time budget is the time budget for coding each respective Macroblock the forms an individual Picture. Thus, prior to encoding a Macroblock j, it is determined whether or not the current MBj is the first MB to be encoded and the system is initialized according to Equation 9:

$$( \text{?} ) \text{?} = ( \text{?} ) \text{?} \\ ( \text{?} ) \text{?} = 0 \\ \text{?} \text{indicates text missing or illegible when filed} \qquad ( 9 )$$

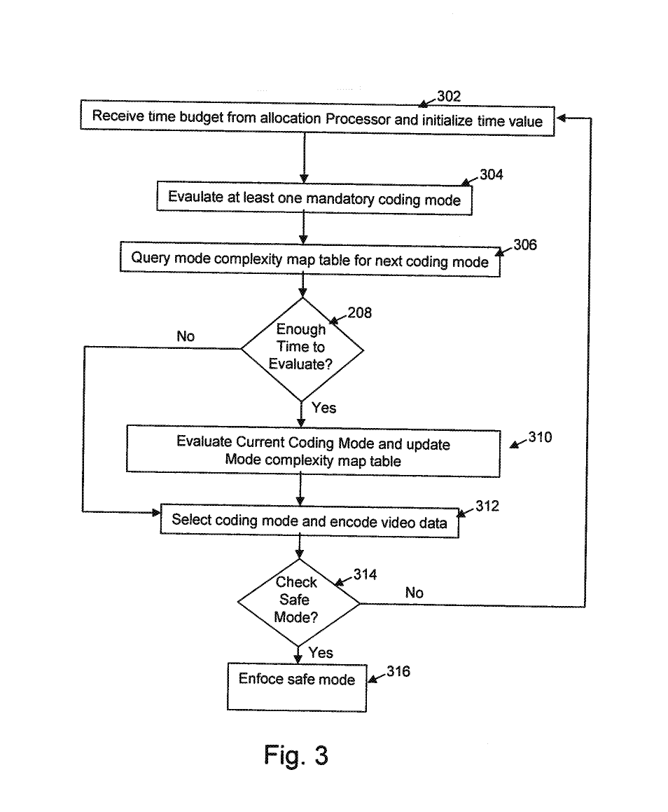

Thereafter, the time budget for Macroblock j is calculated according to Equation 10 which provides

$$( \text{?} \text{?} = \frac{( \text{?} \text{?}}{\text{?} ( \text{?} \text{?}} \cdot ( \text{?} \text{?} \\ \text{?} \text{indicates text missing or illegible when filed} \qquad ( 10 )$$

Where (Cmpl)ᵢ represents the complexity metric for Macroblock k from the pre-analysis processor and M represents the number of Macroblocks in the current Picture. This computed budget can now be ultized by the time budget achievement processor (108 in FIG. 1) as discussed below in FIG. 3 in order to guarantee real-time video encoding performance

$$( \text{?} ) \text{?}$$

$$\text{?} \text{indicates text missing or illegible when filed}$$

is passed on to the achievement processor. The achievement processor may employ various mechanisms in order to constrain the Macroblock encode time to meet the allocated budget requirements.

Unlike at the Picture-level, the use of MB-level model parameters are not required in Equation 10. The requirement is relaxed because only the allocation between MBs of the same Picture-type, independent of their coding mode, is considered. In one embodiment, Equation 10 may be more accurate if it considered model parameters for each possible MB coding mode. However, this approach has two main problems. First, there are a large number of coding modes, especially for P and B Pictures. Second, the coding time for each individual mode is extremely small and exhibits a large amount of variance. Therefore, in practice, only the general coding complexity of the whole Macroblock is considered as shown in Equation 10, rather than individual coding modes.

In block 212, the encoding time associated with the third coding level is updated. For consistent real-time performance, the model parameters are measured and updated along with an actual (i.e. achieved) time budgets. This advantageously enables budget allocations adapt to any changes in the encoding system behavior due to internal or external factors. Internal factors may include encoder configuration changes, content changes, etc whereas external factors include CPU load, thread and process scheduling, memory and disk accesses, etc.

Furthermore, after encoding the Macroblock j, the system updates the remaining time budget the current Picture such that

$$( \text{?} ) \text{?} = ( \text{?} ) \text{?} - ( {T}_{MB} ) \text{?} \\ \text{?} \text{indicates text missing or illegible when filed} \qquad ( 11 )$$

### Where

$$( {T}_{MB} ) \text{?}$$

$$\text{?} \text{indicates text missing or illegible when filed}$$

is the actual achieved Macroblock encoding time. After evaluating Equation 11, it is possible for

$$( \text{?} ) \text{?}$$

$$\text{?} \text{indicates text missing or illegible when filed}$$

to approach zero or be negative. To handle these cases,

$$( \text{?} ) \text{?}$$

$$\text{?} \text{indicates text missing or illegible when filed}$$

is constrained by the minimum time required to encode all of the remaining Macroblocks in this picture as shown below in Equation 12.

$$( \text{?} \text{?} = max ( \text{?} \text{?} \cdot \text{?} ( \text{?} \text{?} ) \\ \text{?} \text{indicates text missing or illegible when filed} \qquad ( 12 )$$

Once the actual coding time for the third level is updated, the system updates at least one parameter associated with the second coding level after the complete second level has been encoded. For example, when the complete Picture has been encoded, the model parameter θ is updated using a sliding window Wθ having a predetermined number of pictures (e.g. 3) defined in Equation 13 as:

$$θ = \frac{1}{\text{?}} \cdot \text{?} \frac{( \text{?} \text{?}}{( Bits \text{?}} \\ \text{?} \text{indicates text missing or illegible when filed} \qquad ( 13 )$$

### Where

$$( \text{?} ) \text{?}$$

$$\text{?} \text{indicates text missing or illegible when filed}$$

represents the actual, achieved encoding time and

$${( Bits )}_{j}^{\text{?}}$$

$$\text{?} \text{indicates text missing or illegible when filed}$$

reprsents the actual bits consumed by Picture I, measured after Picture i has been completely encoded. Moreover, θ is traced separately for each type of Picture that is to be encoded (I, P, and B pictures).

In one embodiment, the updating of the model parameter value may be omitted if the Picture-level complexity (i.e. average of all MB-level complexities from PreProcess) is below a certain threshold

$$Cmp \text{?} . \\ \text{?} \text{indicates text missing or illegible when filed}$$

This is because Pictures with very little or no motion (i.e. low complexity) provide no useful information regarding the time-complexity model relationship. In fact, including such Pictures in the update may adversely affect the modeling of other “normal” Pictures in the video sequence. From our experiments, a reasonable value for

$$\text{?}$$

$$\text{?} \text{indicates text missing or illegible when filed}$$

is 5.

The system then measures and updates

$${( \text{?} )}_{min}$$

$$\text{?} \text{indicates text missing or illegible when filed}$$

using Equation 7 from the current Picture statistics. It should be noted that

$${( \text{?} )}_{\text{?}}$$

$$\text{?} \text{indicates text missing or illegible when filed}$$

is strongly dependent on the capabilities of the platform. Video encoding is generally a CPU bound process rather than an I/O or memory bound process. Therefore, “platform capabilities” can be interpreted as “CPU speed” or a measure of available computational resources. So, for a given combination of CPU processing speed and encoder configuration,

$${( \text{?} )}_{\text{?}}$$

$$\text{?} \text{indicates text missing or illegible when filed}$$

determines an upper bound for the maximum achievable frame rate FR^{Max} as provided in Equation 14

$${FR}^{Max} = \frac{N}{\text{?} ( \text{?} \text{?} + \text{?} \text{?}} \\ \text{?} \text{indicates text missing or illegible when filed} \qquad ( 14 )$$

where N is the GOP size.

Thereafter, the remaining GOP time budget is updated according to Equations 15 and 16 which provide

$$\begin{matrix} ( {T}_{GOP} ) \text{?} = ( {T}_{GOP} ) \text{?} - ( \text{?} ) \text{?} & ( 15 ) \\ ( {T}_{GOP} ) \text{?} = ( {T}_{GOP} ) \text{?} + ( \text{?} ) \text{?} \\ \text{?} \text{indicates text missing or illegible when filed} & ( 16 )\end{matrix}$$

It is possible that after evaluating Equation 15,

$$( {T}_{GOP} ) \text{?}$$

$$\text{?} \text{indicates text missing or illegible when filed}$$

approaches zero or is negative. Thus,

$$( {T}_{GOP} ) \text{?}$$

$$\text{?} \text{indicates text missing or illegible when filed}$$

is constrained by the minimum time required to encode all the remaining pictures in the current GOP as provided in Equation 17:

$$( {T}_{GOP} \text{?} = max ( ( {T}_{GOP} \text{?} \cdot \text{?} ( \text{?} \text{?} + \text{?} \text{?} ) \\ \text{?} \text{indicates text missing or illegible when filed} \qquad ( 17 )$$

In block 216, the system determines if this coded picture is the last coded picture in the current GOP, any carryover time as defined by the difference between calculated encoding time and actual encoding time as is updated for the subsequent GOP.

The inventive time budget allocation algorithm provides a scheme that allocate budgets at three coding levels in order to ensure real-time video encoding efficiency. This allocation includes allocating a time budget at a first coding level (GOP level) based on a size of the GOP, a target frame rate for the GOP and a carryover time representing a difference in calculated and actual encoding time associated with a previous GOP. Additionally, the algorithm models a second coding level time-complexity relationship and optimally distribute the time budget associated with a first coding level amongst the elements of the second coding level (e.g. Pictures that make up a GOP) based on one of a Picture level bit budget, Picture type, picture complexity metric and measured encoder performance.

FIG. 3 is an exemplary flow diagram detailing an algorithm that may be executed by the video encoder 100 of FIG. 1. The algorithm described in FIG. 2 is a time budget achievement algorithm that adaptively and intelligently achieves an allocated time budget when encoding video data. In one embodiment, the algorithm of FIG. 3 is executed by the achievement processor 108 of FIG. 1. In another embodiment, the algorithm as a whole or in part may be executed by any one of (or a combination of) any processor components shown in FIG. 1.

The algorithm of FIG. 3 pertains to the third coding level that encompasses coding of individual Macroblocks of a particular Picture in a GOP. In block 302 the achievement processor receives the time budget having an encoding time budget for the particular Macroblock from the allocation processor. Let M be the number of Macroblocks to be encoded for the current Picture i and j is the index of current Macroblocks to be encoded. The time budget

$${( {T}_{MB} )}_{j}^{\text{?}}$$

$$\text{?} \text{indicates text missing or illegible when filed}$$

is received from the allocation processor and the remaining MB time-budget is initialized to the same value as shown in Equation 18

$$( {T}_{MB} ) \text{?} = ( {T}_{MB} ) \text{?} \\ \text{?} \text{indicates text missing or illegible when filed} \qquad ( 18 )$$

In operation, the remaining MB time budget is subsequently updated after evaluating each coding mode in accordance with Equation 19

$${( \text{?} )}_{\text{?}}^{\text{?}} = {( {T}_{MB} )}_{\text{?}}^{\text{?}} - ( \text{?} ) \\ \text{?} \text{indicates text missing or illegible when filed} \qquad ( 19 )$$

### Where

$$\text{?}$$

$$\text{?} \text{indicates text missing or illegible when filed}$$

represents the time required to evaluate the coding mode Mode without evaluating any other coding mode.

In block 304, at least one mandatory coding mode is evaluated by the achievement processor. The Macroblock coding modes that are the least time consuming are designated as “mandatory” and are always evaluated. This is because the mode decision process requires at least one mode to be checked, even if the allocated time budget cannot be met. It should be noted that in case of SKIP or DIRECT mode (for P and B Pictures respectively), the encoder makes use of inferred motion information and hence little or no additional computation (such as spatial or temporal prediction or Motion Estimation) is necessary. For I Pictures, there is no equivalent to SKIP or DIRECT mode. Intra_{—}16×16 is selected as the mandatory mode since it consumes much less time compared to Intra_{—}4×4 and is far more coding efficient than Intra_PCM. Another property of these chosen modes (SKIP, DIRECT and Intra_{—}16×16) is that their encode time is fairly constant and independent of the video content.

If

$${( \text{?} )}_{\text{?}}$$

$$\text{?} \text{indicates text missing or illegible when filed}$$

represents the least time consuming mode, then for each type of picture discussed above (I, P and B) the following equation 20 applies:

$$( \text{?} \text{?} = \{ \begin{matrix}( \text{?} ) & for I Picture \\ ( \text{?} ) & for P Picture \\ ( \text{?} ) & for B Picture\end{matrix} \\ \text{?} \text{indicates text missing or illegible when filed} \qquad ( 20 )$$

If the Macroblock time-budget is not achieved in spite of coding only mandatory MB modes, it means that the given combination of encoder configuration and platform capabilities (or computing resources) is insufficient to achieve the target real-time encoding frame-rate. Therefore, one or more of these factors need to be changed in order to perform real-time video encoding.

To determine whether or not any other coding modes beyond the mandatory modes are to be evaluated, the achievement processor queries a mode complexity map table in block 306. The mode complexity map table stores data representing a ratio between the actual time required to evaluate a particular coding mode to the complexity (e.g. characteristic of the video picture) of the Macroblock as shown in Equation 21.

$$ModeComplexityMap [ Mode ] = \frac{( \text{?} \text{?}}{( Cmpl )} \\ \text{?} \text{indicates text missing or illegible when filed} \qquad ( 21 )$$

Which may be implemented as a sliding window average of mode-specific complexity ratios as shown in Equation 22 which provides

$$ModeComplexityMap [ Mode ] = \frac{1}{{W}_{M}} \cdot \text{?} \frac{( \text{?} \text{?}}{( Cmpl \text{?}} \\ \text{?} \text{indicates text missing or illegible when filed} \qquad ( 22 )$$

### Where

$${( \text{?} )}_{\text{?}}^{\text{?}}$$

$$\text{?} \text{indicates text missing or illegible when filed}$$

reprsents the actual, measured coding time of previously coded Macroblock i using coding mode Mode and (Cmpl)ᵢ represents the MB level complexity metric and WM represents a sliding window having a predetermined size (e.g. 5). The complex metric (Cmpl)ᵢ is computed for each MB by the pre-analysis processor (102 in FIG. 1) before the actual encoding begins. It is obtained by first performing a simplified motion estimation process using single reference forward prediction, only Inter_{—}16×16 mode and sub-pixel search. The resulting motion vector coding bits and the MAD (Mean Absolute Difference) of the motion estimation error are summed to yield the final complexity metric. Further details on this metric can be found in [5] and [6]. At the start of the encoding process (i=0), all the entries in the ModeComplexityMap are initialized to zero.

The formulation in (22) tracks the relationship between coding time and complexity for each coding mode, over a short window. This allows the ModeComplexityMap (and hence the achievement mechanism) to dynamically adapt to any changes in the encoder's performance, platform capabilities or computing resources. There are other factors that may affect the time budget achievement process. For example, the maximum number of reference pictures allowed and the maximum motion estimation search range can greatly affect the time consumed by each coding mode. The assumption made in our scheme is that these factors would uniformly affect the encoding time of all the Macroblocks of the current Picture. Therefore, only the time-complexity relationship is considered in the Mode Complexity Map table and results in the The Mode Complexity Map being queried to determine whether

$${( {T}_{MB} )}_{\text{?}}^{\text{?}}$$

$$\text{?} \text{indicates text missing or illegible when filed}$$

will be sufficient to evaluate the current MB coding mode.

In block 308, the system queries, based on the values in the Mode Complexity Map table, whether or not there is sufficient time to evaluate a current coding mode. If the query is positive, then the algorithm continues at block 310 whereby the current coding mode is evaluated and the table is updated with the resulting evaluation value. The evaluation of the current Macroblock may include spatial or temporal prediction, motion estimation and compensation and residue coding (transform, quantization and entropy coding). The actual time consumed by the currently evaluated coding mode is measured and the time-complexity ratio is updated in the appropriate index of the ModeComplexityMap table stored in memory.

If the result of the query in block 308 is negative, the algorithm selects a coding mode in block 312 to code the particular Macroblock. The achievement algorithm further includes an error correction aspect whereby the encoding budget is only sufficient to evaluate the mandatory coding modes. For certain types of pictures (e.g. B and P pictures), this means that several Macroblocks may be encoded using SKIP or DIRECT modes. For video sequences with a high amount of motion, this may result in annoying visual artifacts. Therefore, it is necessary to correctly detect such “bad SKIP” or “bad DIRECT” modes and correct them by enforcing “Safe” modes. These “Safe” modes may use inferred motion information along with proper residue coding in order to limit the amount of distortion which greatly improves visual quality while maintaining the real-time encoding constraint.

Additionally, the methods may be implemented by instructions being performed by a processor, and such instructions may be stored on a processor or computer-readable media such as, for example, an integrated circuit, a software carrier or other storage device such as, for example, a hard disk, a compact diskette, a random access memory (“RAM”), a read-only memory (“ROM”) or any other magnetic, optical, or solid state media. The instructions may form an application program tangibly embodied on a computer-readable medium such as any of the media listed above. As should be clear, a processor may include, as part of the processor unit, a computer-readable media having, for example, instructions for carrying out a process. The instructions, corresponding to the method of the present invention, when executed, can transform a general purpose computer into a specific machine that performs the methods of the present invention.

What has been described above includes examples of the embodiments. It is, of course, not possible to describe every conceivable combination of components or methodologies for purposes of describing the embodiments, but one of ordinary skill in the art can recognize that many further combinations and permutations of the embodiments are possible. Accordingly, the subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A video encoder comprising:
a pre-analysis processor that processes unencoded video data formed from a series of video pictures into respective video segments;
an allocation processor that allocates
a first encoding time budget to a respective video segment respective video segment based on a size of the respective segment a target frame rate for the respective video segment,
a second encoding time budget to individual pictures that form the respective video segment based on a picture-level complexity value and a type of picture, the second time budget for all individual pictures being substantially equal to the first time budget, and
a third encoding time budget to individual blocks that form respective ones of the individual pictures based on a coding mode for the individual block and a block complexity value, the third time budget for all blocks being substantially equal to the second time budget for the respective individual picture that includes the blocks; and
an encoding processor that encodes respective video segments using the third time budget to encode the video segment using the first, second and third time budgets.

2. The encoder of claim 1, wherein
the pre-analysis processor determines a size of the video segment and a pattern of types of pictures to be included within the video segment.

3. The encoder of claim 1, wherein
each video segment is formed from a plurality of individual pictures and each of the individual pictures is formed from a plurality of macroblocks.

4. The encoder of claim 1, wherein
the allocation processor measures an amount of time to encode the video segment.

5. The encoder of claim 1, wherein
the allocation processor determines a carry over amount of time by calculating a difference between an actual amount of time to encode a prior video segment and the first time budget associated with the prior video segment.

6. The encoder of claim 5, wherein
the first time budget is further allocated based on the carry over amount of time.

7. The encoder of claim 1, further comprising
a rate control module for allocating an amount of bits associated with the video segment and respective pictures that form the video segment.

8. The encoder of claim 1, wherein
the allocation processor allocates the second encoding time budget based on a number of bits allocated to the individual picture and a picture level complexity characteristic.

9. The encoder of claim 1, wherein
the allocation processor distributes the allocated first encoding time budget amongst all individual pictures included in the video segment.

10. The encoder of claim 1, wherein
the allocation processor
measures an overhead time associated with each type of picture within the respective video segment;
determines a minimum amount of encoding time needed to encode all remaining pictures of the video segment;
identifies an available amount of encoding time for the individual picture by obtaining a difference between the overhead time and the first encoding time budget; and
calculates a second encoding time budget for the individual picture based on a second level coding parameter.

11. The encoder of claim 10, wherein
The second level coding parameter includes at least one of (a) an amount of bits associated with the individual picture, (b) a ratio between an actual encoding time for a previous picture of the same type and an amount of total allocated bits for the current picture; and (c) a ratio between an actual encoding time for a previous picture of the same type and an actual complexity characteristic for the current picture.

12. The encoder of claim 1, wherein
the pre-analysis processor calculates a complexity characteristic associated with block the forms respective individual pictures of a respective video segment.

13. The encoder of claim 12, wherein
the allocation processor allocates the third time budget for each block the forms a respective individual picture using the complexity characteristic associated with the respective block.

14. The encoder of claim 1, wherein
the allocation processor, in response to encoding of a respective block by the encoding processor, updates a remaining amount of time of the second encoding time budget to adaptively re-allocate one of the second encoding time budget and third encoding time budget.

15. The encoder of claim 1, further comprising
An achievement processor that receives the third encoding time budget from the allocation processor and selectively determines a coding mode for encoding a respective block in an amount of time less than or equal to the third encoding time budget.

16. The encoder of claim 15, wherein
the achievement processor selectively evaluates at least one coding mode available for encoding the a respective block associated with an individual picture of the video segment.

17. The encoder of claim 15, wherein
The encoding processor designates at least one type of coding mode as a mandatory coding mode and the achievement processor selectively evaluates the at least one mandatory coding mode to determine if coding the block using the at least one mandatory coding mode in an amount of time remaining in the third encoding time budget.

18. The encoder of claim 15, wherein
the achievement processor generates a coding complexity map including data representing a ratio between an actual time required to evaluate a particular coding mode and a complexity characteristic of the respective block.

19. The encoder of claim 18, wherein
the coding complexity map tracks a relationship between a coding time and block complexity for each coding mode over a predetermined window of time.

20. A method of encoding video comprising the activities of:
processing unencoded video formed from a series of video pictures into respective video segments;
allocating a first encoding time budget to a respective video segment respective video segment based on a size of the respective segment a target frame rate for the respective video segment;
allocating a second encoding time budget to individual pictures that form the respective video segment based on a picture-level complexity value and a type of picture, the second time budget for all individual pictures being substantially equal to the first time budget, and
allocating a third encoding time budget to individual blocks that form respective ones of the individual pictures based on a coding mode for the individual block and a block complexity value, the third time budget for all blocks being substantially equal to the second time budget for the respective individual picture that includes the blocks; and
encoding encodes respective video segments using the third time budget to encode the video segment using the first, second and third time budgets.

21. The method of claim 20, further comprising
determining a size of the video segment and a pattern of types of pictures to be included within the video segment.

22. The method of claim 20, wherein
each video segment is formed from a plurality of individual pictures and each of the individual pictures is formed from a plurality of macroblocks.

23. The method of claim 20, further comprising
measuring an amount of time to encode the video segment.

24. The method of claim 20, further comprising
determining a carry over amount of time by calculating a difference between an actual amount of time to encode a prior video segment and the first time budget associated with the prior video segment.

25. The method of claim 24, wherein the activity of allocating the first time budget further comprises
allocating the first time budget based on the carry over amount of time.

26. The method of claim 20, further comprising
allocating an amount of bits associated with the video segment and respective pictures that form the video segment.

27. The method of claim 20, wherein the activity of allocating the second time budget further includes
allocating based on a number of bits allocated to the individual picture and a picture level complexity characteristic.

28. The method of claim 20, further comprising
distributing the allocated first encoding time budget amongst all individual pictures included in the video segment.

29. The method of claim 20, further comprises
measuring an overhead time associated with each type of picture within the respective video segment;
determining a minimum amount of encoding time needed to encode all remaining pictures of the video segment;
identifying an available amount of encoding time for the individual picture by obtaining a difference between the overhead time and the first encoding time budget; and
calculating a second encoding time budget for the individual picture based on a second level coding parameter.

30. The method of claim 29, wherein
the second level coding parameter includes at least one of (a) an amount of bits associated with the individual picture, (b) a ratio between an actual encoding time for a previous picture of the same type and an amount of total allocated bits for the current picture; and (c) a ratio between an actual encoding time for a previous picture of the same type and an actual complexity characteristic for the current picture.

31. The method of claim 20, further comprising
calculating a complexity characteristic associated with block the forms respective individual pictures of a respective video segment.

32. The method of claim 31, further comprising
allocating the third time budget for each block the forms a respective individual picture using the complexity characteristic associated with the respective block.

33. The method of claim 20, further comprising
updating a remaining amount of time of the second encoding time budget to adaptively re-allocate one of the second encoding time budget and third encoding time budget in response to encoding of a respective block by the encoding processor.

34. The method of claim 20, further comprising
receiving the third encoding time budget and selectively determining a coding mode for encoding a respective block in an amount of time less than or equal to the third encoding time budget.

35. The method of claim 34, further comprising
selectively evaluating at least one coding mode available for encoding the a respective block associated with an individual picture of the video segment.

36. The method of claim 34, further comprising
designating at least one type of coding mode as a mandatory coding mode and the selectively evaluating the at least one mandatory coding mode to determine if coding the block using the at least one mandatory coding mode in an amount of time remaining in the third encoding time budget.

37. The method of claim 34, further comprising
generating a coding complexity map including data representing a ratio between an actual time required to evaluate a particular coding mode and a complexity characteristic of the respective block.

38. The method of claim 37, further comprising
tracks a relationship between a coding time and block complexity for each coding mode over a predetermined window of time using the generated coding complexity map.
